(19) United States
(12) Patent Application Publication
(10) Pub. No.: US 2026/0196730 A1
(43) Pub. Date: Jul. 9, 2026

(54) ANTENNA DEVICE AND ANTENNA SYSTEM

(71) Applicant: HUAWEI TECHNOLOGIES CO., LTD., Shenzhen (CN)

(72) Inventors: Ignacio Gonzalez, Munich (DE); Bruno Biscontini, Munich (DE); Xu Liu, Shanghai (CN); Fabrizio Gentili, Munich (DE); Grzegorz Wolosinski, Munich (DE)

(21) Appl. No.: 19/466,838

(22) Filed: Feb. 2, 2026

Related U.S. Application Data
(63) Continuation of application No. PCT/EP2023/071551, filed on Aug. 3, 2023.

(51) Int. Cl. H01Q 5/42; H01Q 3/36; H01Q 9/06; H01Q 21/12

(52) U.S. Cl. CPC H01Q 5/42; H01Q 3/36; H01Q 9/065; H01Q 21/12

(57) ABSTRACT

An antenna device includes a node and a first radiating element in a first plane and coupled with the node. The first radiating element is configured to radiate a radio wave in response to a radio frequency (RF) signal being fed to the first radiating element by way of the node. The antenna device also includes a second radiating element in a second plane different from the first plane and coupled with the node. The second radiating element is configured to radiate a radio wave in response to the RF signal being fed to the second radiating element by way of the node. The antenna device further includes a non-reflective plate in a third plane different from the first plane and the second plane. The first radiating element is between the second radiating element and the non-reflective plate.

### CROSS-REFERENCE TO RELATED APPLICATIONS

This application is a of International Application No. PCT/EP2023/071551, filed on Aug. 3, 2023, the disclosure of which is hereby incorporated by reference in its entirety.

### TECHNICAL FIELD

The present disclosure relates to an antenna device and an antenna system, in particular with regard to arranging two antenna devices such that one of the antenna devices radiates radio waves through the other one of the antenna devices.

### BACKGROUND

With the Long Term Evolution (LTE) rollout already complete and the 5^{th} generation mobile network (5G) rollout ongoing, operators are preparing their networks for the upcoming 5.5 generation mobile network (5.5G). One key technology for enabling this new generation of mobile communications is massive multiple input multiple output (mMIMO) below 6 GHz.

### SUMMARY

The regulations in most countries, especially in Europe, are a limiting factor when rolling out new services and infrastructures and are likely going to be developed slower than technology. To facilitate the site acquisition and fulfill the local regulations regarding site upgrades, dimension of new antennas are desired to be comparable to legacy products. In addition, to be able to maintain mechanical support structures in the sites, the wind load of new antennas are desired to be equivalent to the previous ones. These factors lead to a very strict limitation in width of an antenna. With width limitations come other strings attached. Multiband antenna arrays require techniques such as interleaving or stacking to enable different bands over the same aperture.

The regulations in most countries, especially in Europe, are a limiting factor when rolling out new services and infrastructures and are likely going to be developed slower than technology. To facilitate the site acquisition and fulfill the local regulations regarding site upgrades, dimension of new antennas are desired to be comparable to legacy products. In addition, to be able to maintain mechanical support structures in the sites, the wind load of new antennas are desired to be equivalent to the previous ones. These factors lead to a very strict limitation in width of an antenna. With width limitations come other strings attached. Multiband antenna arrays require techniques such as interleaving or stacking to enable different bands over the same aperture.

Having several bands in an antenna configuration is to build multiple antenna devices using the same physical/mechanical support and optionally sharing the same reflector. Under these constrains and to provide deployment flexibility, there may be an antenna system comprising two antenna devices, wherein one of the two antenna devices is rear mounted on the back of the other antenna device, wherein the side (i.e. front) of each antenna device from which radio waves are radiated face in the same direction. That is, the aforementioned side (i.e. font) of the antenna device, which is rear mounted on the back of the other antenna device, faces the back of the other antenna device. Optionally the aforementioned side (i.e. font) of the antenna device, which is rear mounted on the back of the other antenna device, is at least partly in contact with the back of the other antenna device. The two antenna devices may be sold independently from each other as separate products. The two antenna devices may have separated physical enclosures and, thus, the two antenna devices do not share the same reflector.

An example of such an antenna system product may be referred to as A+P (i.e. active+passive) antenna system. This type of antenna system may comprise a passive antenna device and an active antenna device, wherein the active antenna device is rear mounted on the back of the passive antenna device. The back of an antenna device may be understood as the side of the antenna device at which a reflector may be arranged for reflecting radio waves radiated by one or more radiating elements of the antenna device away from the reflector. That is, the back of the antenna device may be the side of the antenna device that is opposite to a side of the antenna device at which radio waves are intended to be radiated to the outside of the antenna device. The side of the antenna device at which radio waves are radiated to the outside of the antenna device is the front of the antenna device. Thus, in order for the two antenna devices to radiate in the same main radiating direction, the antenna device that is rear mounted on the back of the other antenna device is mounted to the back of the other antenna device such that the antenna device radiates radio waves through the other antenna device. Since the active and passive antenna device may be sold independently and they have separate physical enclosures, they do not share the same reflector.

FIG. 1 shows an example of an antenna device, such as an active antenna device or a passive antenna device. The antenna device 100 of FIG. 1 comprises a radiating source 101 for radiating a radio wave in response to a radio frequency (RF) signal being fed to the radiating source 101 and a reflector 102, e.g. in the form of a reflector plate. The radiating source 101 may comprise one or more radiating elements for radiating radio waves (not shown in FIG. 1). As indicated in FIG. 1, the radiating source 101 and, thus, the antenna device 100 may radiate radio waves in a main radiating direction MRD. For this, radio waves (indicated by dashed arrows in FIG. 1) that are radiated by the radiating source 101 may be reflected by the reflector 102 such that they radiate in the direction of the main radiating direction MRD (after the reflection). Since, the reflector 102 is reflective for radio waves, radio waves can not pass through the reflector 102. Therefore, the antenna device 100 of FIG. 1 can not be used for rear mounting another antenna device on the back of the antenna device 100, i.e. at a side of the reflector 102 that is opposite to a side of the reflector at which the radiating source 101 is arranged.

To overcome this, a reflector with a frequency selective behavior, e.g. a reflector comprising a frequency selective surface (FSS), may be used. Such a reflector may be implemented using one or more metamaterials. That is, such a reflector may comprise a metasurface. Such a reflector with frequency selective behavior may be reflective for radio waves at certain frequencies and may allow radio waves at different frequencies to pass through. Thus, using the aforementioned reflector allows rear mounting an antenna device on the back of another antenna device. An example of this is shown in FIG. 2. FIG. 2 shows an example of two antenna devices arranged together.

A first antenna device 200 comprises a radiating source 201 for radiating a radio wave in response to a radio frequency (RF) signal being fed to the radiating source 101 and a reflector 202, e.g. in the form of a reflector plate. The radiating source 201 may comprise one or more radiating elements for radiating radio waves (not shown in FIG. 2). The reflector may be formed by a metasurface 202a. The metasurface 202a may be reflective for radio waves radiated by the radiating source 201. Such radio waves are represented in FIG. 2 by dashed arrows. The metasurface 202a may allow radio waves radiated by a radiating source 301 of a second antenna device 300 to pass through. Such radio waves radiated by the second antenna device 300 are represented in FIG. 2 by solid arrows. For this, the radio waves radiated by the second antenna device 300 may be radiated at one or more different frequencies compared to one or more frequencies of the radio waves radiated by the first antenna device 200. Thus, a frequency selective behavior of the metasurface being a FSS may allow the radio waves radiated by the second antenna device 300 to pass through the reflector 202 and the radio waves radiated by the first antenna device 200 to be reflected by the reflector 202. As a result, the first antenna device 200 and the second antenna device 300 may radiate radio waves in a common main radiating direction MRD. The second antenna device 300 may comprise a reflector 302 and may be implemented in line with the antenna device 100 of FIG. 1. That is, the second antenna device 300 may be the antenna device 100 of FIG. 1. The metasurface 202a of the reflector 202 allows rear mounting the second antenna device 300 on the back of the first antenna device 200. A disadvantage of using a FFS is that there may be losses on the FSS as some radio waves radiated by the second antenna device 300 may be prevented from passing through the FFS e.g. by reflection. Another disadvantage of Using FFS is a limited bandwidth.

In view of the above, this disclosure aims to provide an antenna device that allows rear mounting another antenna device on the back of the antenna device such that the other antenna device may radiate radio waves in the direction of the back of the antenna device. An objective of this disclosure is to provide such an antenna device comprising a sufficient radiation of radio waves in a main radiating direction away from the back of the antenna device.

These and other objectives are achieved by the solution of this disclosure as described in the independent claims. Advantageous implementations are further defined in the dependent claims.

A first aspect of this disclosure provides an antenna device. The antenna device comprises a node for being fed with a radio frequency (RF) signal from a feed structure. The antenna device comprises a first radiating element being arranged in a first plane and configured to radiate a radio wave in response to the RF signal being fed to the first radiating element via the node. The antenna device comprises a second radiating element being arranged in a second plane that is different to the first plane and being configured to radiate a radio wave in response to the RF signal being fed to the second radiating element via the node. The antenna device comprises a non-reflective plate arranged in a third plane that is different to the first plane and the second plane. The antenna device is configured such that the RF signal is fed via the node to the first radiating element and the second radiating element with a difference of phase between the first radiating element and the second radiating element. The first radiating element is arranged between the second radiating element and the non-reflective plate.

In other words, the first aspect proposes to use a dual layer antenna comprising the first radiating element and the second radiating element and using a non-reflective plate instead of a reflector. The non-reflective plate allows radio waves to pass through and, thus, allows rear mounting another antenna device on the back of the antenna device such that the other antenna device may radiate radio waves in the direction of the back of the antenna device. The first radiating element and the second radiating element may be referred to as dual layer antenna. The term “radio frequency signal (RF signal)” may be abbreviated by the term “radio signal”. The dual layer antenna, i.e. the first and second radiating element, allows increasing a directivity of the antenna device with regard to radiating radio waves and, thus, RF signals in the form of radio waves. This allows using the non-reflective plate instead of a reflector (e.g. antenna reflector) while still allowing a sufficient radiation of radio waves in a main radiating direction away from the back of the antenna device; or an increase in coverage and/or an increased signal to interference plus noise ratio (SINR) provided by the antenna device.

The first radiating element, second radiating element and the node for being fed from a feed structure may be an antenna element, and the antenna device may comprise two or more of said antenna element. These two or more antenna elements may form an antenna array. In other words, the antenna device may comprise an antenna array comprising one or more antenna elements, wherein each antenna element comprises the first radiating element, the second radiating element and the node for being fed from a feed structure. The description with regard to the first radiating element, second radiating element and the node for being fed from a feed structure is correspondingly valid for each antenna element of the optional antenna array of the antenna device.

The term “antenna arrangement” may be used instead of the term “antenna device”. The term “feeding network” may be used as a synonym for the term “feed structure”. The terms “phase difference”, “phase shift” and “difference in phase” may be used as a synonym for the passage “difference of phase”.

The non-reflective plate is to be understood as a plate that is in general not reflective for radio waves and allows radio waves to pass through. That is, the non-reflective plate allows radio waves to pass through. Therefore, any antenna device may radiate radio waves through the non-reflective plate. Since the non-reflective plate allows radio waves to pass through, the first radiating element and the second radiating element are configured to radiate radio waves without a reflection of the radio waves on a reflector in response to the RF signal being fed to the first radiating element and the second radiating element from the node. The non-reflective plate being in general not reflective means that there is no intended reflection at the non-reflective plate of radio waves radiated from the first radiating element and the second radiating element. Thus, the non-reflective plate may be understood to be a plate that mainly does not reflect radio waves. Nevertheless, there may be possibly a negligible reflection of radio waves at the plate, when radio waves interact with the plate.

The non-reflective plate may be a planar element arranged in the third plane that allows radio waves to pass through. The non-reflective plate may be made of one or more materials that allow radio waves to pass through. For example, the one or more materials may comprise at least one of one or more plastics, one or more dielectrics etc. The non-reflective plate may be made of a material composition that allows radio waves to pass through. For example, the non-reflective plate does not comprise or is not made of, at least in an area through which radio waves are intended to pass through, one or materials that are reflective for radio waves (e.g. one or more metals). The antenna device may comprise the non-reflective plate instead of a reflector. The antenna device may comprise the non-reflective plate instead of a reflector for reflecting radio waves radiated by the first radiating element and/or the second radiating element. The antenna device may comprise the non-reflective plate instead of a reflector for achieving a main radiation of the antenna device. The non-reflective plate may be arranged in the antenna device at a position, at which a reflector for achieving a main radiation of the antenna device would be usually arranged in the antenna device. That is, the non-reflective plate may be arranged at a position of the antenna device for arranging a reflector, the reflector being configured to effect or influence a main radiation of the antenna device.

For example, the antenna device does not comprise a reflector. For instance, the antenna device does not comprise a reflector in a space behind and in front of the non-reflective plate. In other words, the antenna device optionally does not comprise a reflector in an area, in which the non-reflective plate is arranged. For example, the antenna device does not comprise a reflector for reflecting radio waves radiated by the first radiating element and/or the second radiating element. For example, the antenna device does not comprise a reflector for achieving a main radiation of the antenna device.

The first plane and the second plane may be parallel to each other. The first plane, the second plane and the third plane may be parallel to each other.

The first radiating element, the second radiating element and the non-reflective plate may be positioned such that the radio waves radiated by the first radiating element and the second radiating element are radiated in a main radiating direction away from the non-reflective plate. For example, the antenna device does not comprise a reflector for achieving the radiation of the antenna device in the main radiating direction. For instance, the antenna device does not comprise a reflector for reflecting radio waves radiated by the first radiating element and/or the second radiating element to achieve the radiation of the antenna device in the main radiating direction. For example, the antenna device does not comprise a reflector for reflecting radio waves, which are radiated by the first radiating element and/or the second radiating element, such that they are radiated in the main radiating direction after reflection.

For example, between the first radiating element and the second radiating element no elements are arranged that effect radiation of radio waves by the first radiating element and second radiating element. Optionally, between the first radiating element and the second radiating element no elements are arranged that effect a main radiation of the antenna device provided by the first radiating element and second radiating element. For example, between the first radiating element and the non-reflective plate no elements are arranged that effect radiation of radio waves by the first radiating element and second radiating element. Optionally, between the first radiating element and the non-reflective plate no elements are arranged that effect a main radiation of the antenna device provided by the first radiating element and second radiating element. The terms “have an effect on” and “have an influence on” may be used as synonyms for the term “effect”.

The non-reflective plate may be configured to arrange or position a support structure configured to hold the first radiating element and the second radiating structure. That is, the support structure may be arranged on the non-reflective plate for holding the first radiating element and the second radiating structure. The support structure may be configured to hold the first radiating element and the second radiating structure such that the first and second radiating elements are arranged on a common axis. The support structure may provide a physical support for the first radiating element and second radiating element. The support structure may be arranged perpendicular on the non-reflective plate. The support structure may be a planar element. The support structure may be continuous or not.

The antenna device may be a broadband antenna device and/or may be an antenna device that is suitable for massive multiple input multiple output (mMIMO). The antenna device may be a massive multiple input multiple output antenna device (mMIMO antenna device).

The antenna device of the first aspect is described as a transmission (not reception) device. However, it can also be operated as a reception device.

In an implementation form of the first aspect, the first radiating element and the second radiating element are positioned such that the radio waves radiated by the first radiating element and the second radiating element interfere constructively in a main radiating direction.

The result may be a combined radiation pattern, which is more directive than the radio wave of a simple/single radiating element. The overall result may be a significant increase in the directivity of the combined radiation pattern of the antenna device. This allows using the non-reflective plate instead of a reflector (e.g. antenna reflector) or an increased signal to interference plus noise ratio (SINR) provided by the antenna device. Thus, the directivity of the antenna device radiation may be improved without sacrificing signal gain.

In an implementation form of the first aspect, the antenna device comprises a phase shifter arranged between the node and the first radiating element or second radiating element. That is, the phase shifter may either be arranged between the node and the first radiating element or the node and the second radiating element. The phase shifter may be configured to provide the difference of phase between the first radiating element and the second radiating element of the RF signal when the RF signal is fed to the first radiating element and the second radiating element via the node.

The phase shifter may be configured to control the difference of phase between the first radiating element and the second radiating element. The difference of phase between the first radiating element and the second radiating element may be used to improve front to back and cross-polar discrimination of the antenna device. The phase shifter may be a digital phase shifter or an analog phase shifter.

The first radiating element and the second radiating element may be positioned such and the phase shifter may be configured such that the radio waves radiated by the first radiating element and the second radiating element are radiated in a main radiating direction away from the non-reflective plate.

In an implementation form of the first aspect, the first radiating element and the second radiating element are positioned such and the phase shifter is configured such that the radio waves radiated by the first radiating element and the second radiating element interfere constructively in a main radiating direction.

The result may be a combined radiation pattern, which is more directive than the radio wave of a simple/single radiating element. The overall result may be a significant increase in the directivity of the combined radiation pattern of the antenna device. This allows using the non-reflective plate instead of a reflector (e.g. antenna reflector) or an increased gain provided by the antenna device. Thus, the directivity of the antenna device radiation may be improved without sacrificing signal gain.

The phase shifter may be configured to control the difference of phase between the first radiating element and the second radiating element such that the radio waves radiated by the first radiating element and the second radiating element interfere constructively in the main radiating direction.

In an implementation form of the first aspect, the first radiating element, the second radiating element and the non-reflective plate are arranged on a common axis.

In an implementation form of the first aspect, the main radiating direction is the direction away from the non-reflective plate.

In an implementation form of the first aspect, the first radiating element and the second radiating element are stacked to each other.

The first radiating element and second radiating element may be stacked in the normal direction with respect to the non-reflective plate.

In an implementation form of the first aspect, the first radiating element and the second radiating element each comprise a dipole.

For example, the first radiating element and the second radiating element may each comprise a planar element arranged in its respective plane, e.g. a printed circuit board (PCB) substrate on which a radiating structure, e.g. a dipole, is defined.

In an implementation form of the first aspect, the antenna device is configured to be connected with a further antenna device such that the further antenna device is arranged at a first side of the non-reflective plate that is opposite to a second side of the non-reflective plate, at which the first radiating element and the second radiating element are arranged.

The first side of the non-reflective plate may be referred to as “back” or “back side” of the non-reflective plate and the second side of the non-reflective plate may be referred to as “front” or “front side” of the non-reflective plate with regard to radiation of radio waves by the first and second radiating element, wherein the radio waves are radiated at a front side of the antenna device in a main radiating direction away from a back side of the antenna device. Thus, the first side of the non-reflective plate is directed towards a back side of the antenna device and the second side of the non-reflective plate is directed towards a front side of the antenna device. The terms “back” and “front” may be used as synonyms for the terms “back side” and “front side”, respectively.

The antenna device may be configured such that a further antenna device is mounted to the antenna device at a side of the antenna device corresponding to the first side of the non-reflective plate. In other words, the antenna device may be configured for rear mounting the further antenna device on the back of the antenna device. The antenna device may be configured for mounting the further antenna device to the antenna device at the side of the antenna device corresponding to the first side of the non-reflective plate such that a main radiating direction of the further antenna device is in a direction towards the non-reflective plate of the antenna device. That is, the antenna device may be configured for mounting the further antenna device to the antenna device at the side of the antenna device corresponding to the first side of the non-reflective plate such that the further antenna device is configured to radiate radio waves through the non-reflective plate of the antenna device.

The antenna device may comprise a housing, such as a radome, enclosing the first radiating element, the second radiating element and the non-reflective plate. The housing of the antenna device may be configured to be connected with a housing (e.g. radome) of a further antenna device such that the housing of the further antenna device is arranged at a side of the housing of the antenna device at which the non-reflective plate is arranged in the housing. This side may be referred to as back side of the housing of the antenna device. In other words, the housing of the antenna device may be configured for rear mounting the housing of the further antenna device on the back of the housing of the antenna device. The housing of the antenna device may be configured for mounting the housing of the further antenna device to the housing of the antenna device at the side of the housing of the antenna device, at which the non-reflective plate is arranged in the housing, such that a main radiating direction of the further antenna device is in a direction towards the non-reflective plate of the antenna device. The back side of the housing of the antenna device and the front side of the housing of the antenna device may be referred to as back side of the antenna device and front side of the antenna device, respectively. The term “enclosure” may be used as a synonym for the term “housing”.

At least a part of at least one of the first radiating element, second radiating element and non-reflective plate may be arranged outside the housing or protrude out of the housing.

In an implementation form of the first aspect, the antenna device is a passive antenna device; Alternatively, the antenna device may be an active antenna device.

In an implementation form of the first aspect, the antenna device comprises the feed structure that is configured to feed the RF signal to the node of the antenna device.

The first and second radiating element may be configured to receive the RF signal with the phase difference between them via the node from the feed structure. The feed structure may be configured to feed the RF signal such that the first radiating element and second radiating element are fed and radiate at the same frequencies. The first radiating element and the second radiating element may be configured to be fed at the same frequencies. The first radiating element and the second radiating element may be configured to radiate at the same frequencies.

In order to achieve the antenna device according to the first aspect of this disclosure, some or all of the implementation forms and optional features of the first aspect, as described above, may be combined with each other.

A second aspect of this disclosure provides an antenna system comprising an antenna device according to the first aspect of this disclosure, as described above, and a second antenna device. The antenna device and the second antenna device are configured to be arranged such that the non-reflective plate of the antenna device is arranged between the first radiating element of the antenna device and the second antenna device. The second antenna device is configured to radiate one or more radio waves in the direction of the non-reflective plate.

The antenna device may be a passive antenna device and the second antenna device may be an active antenna device. The second antenna device may optionally comprise a reflector, i.e. an antenna reflector.

The second antenna device may be a broadband antenna device and/or may be an antenna device that is suitable for massive multiple input multiple output (mMIMO). The second antenna device may be a massive multiple input multiple output antenna device (mMIMO antenna device). According to an example, the second antenna device may be an antenna device according to the first aspect.

The antenna device and the second antenna device each may comprise a housing, such as a radome. The housing of the antenna device may enclose the first radiating element, the second radiating element and the non-reflective plate. The housing of the second antenna device may enclose one or more radiating elements of the second antenna device and optionally one or more other components, such as a reflector. The housing of the antenna device may be configured to be connected with the housing of the second antenna device such that the housing of the second antenna device is arranged at a side of the housing of the antenna device at which the non-reflective plate is arranged in the housing of the antenna device. This side may be referred to as back side of the housing of the antenna device. In other words, the housing of the second antenna device may be configured to be rear mounted on the back of the housing of the antenna device. The housing of the second antenna device may be configured to be mounted to the housing of the antenna device at the side of the housing of the antenna device, at which the non-reflective plate is arranged in the housing, such that a main radiating direction of the second antenna device is in a direction towards the non-reflective plate of the antenna device. The housing of the second antenna device may be configured to be connected or mounted to the housing of the antenna device according to the aforementioned description in an area of the antenna device, in which the non-reflective plate is arranged.

At least a part of at least one of the first radiating element, second radiating element and non-reflective plate of the antenna device may be arranged outside the housing or protrude out of the housing. At least a part of the one or more radiating elements and optionally of the one or more optional other components of the second antenna device may be arranged outside the second antenna device or protrude out of the housing of the second antenna device.

In an implementation form of the second aspect, the antenna device and the second antenna device each comprise a radome.

The radome of the antenna device and the radome of the second antenna device are independent of each other. That is, they are independent radomes.

In an implementation form of the second aspect, the antenna device and the second antenna device are configured to work on different frequency bands. In other words, the antenna device and the second antenna device may be configured to radiate radio waves on different frequency bands. That is, the antenna device may be configured to work, i.e. radiate radio waves, on a first frequency band and the second antenna device may be configured to work, i.e. radiate radio waves, on a second frequency band, wherein the first frequency band is different to the second frequency band.

The antenna device and the second antenna device may be configured to be arranged or placed in a laminated manner.

The above description of the antenna device according to the first aspect is correspondingly valid for the antenna system according to the second aspect. The above description of the antenna system according to the second aspect is correspondingly valid for the antenna device according to the first aspect.

The antenna system of the second aspect and its implementation forms and optional features achieve the same advantages as the antenna device of the first aspect and its respective implementation forms and respective optional features.

In order to achieve the antenna system according to the second aspect of this disclosure, some or all of the implementation forms and optional features of the second aspect, as described above, may be combined with each other.

It has to be noted that all devices, elements, units and means described in the present application could be implemented in software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of example embodiments in relation to the enclosed drawings, in which

FIG. 1 shows an example of an antenna device;

FIG. 2 shows an example of two antenna devices arranged together;

FIG. 3 (a) shows an example of an antenna device according to this disclosure;

FIG. 3 (b) shows an example of an antenna device according to this disclosure;

FIG. 3 (c) shows an example of an antenna device according to this disclosure;

FIG. 4 shows an example of an antenna system according to this disclosure;

FIG. 5 (a) shows an example of the second antenna device of the antenna system of FIG. 4;

FIG. 5 (b) shows an example of the second antenna device of the antenna system of FIG. 4;

FIG. 6 (a) shows an example of a radiation pattern of an antenna device;

FIG. 6 (b) shows an example of a radiation pattern of the antenna device according to FIGS. 3 (a), 3 (b) and 3 (c); and

FIG. 7 shows an example of an implementation form of the antenna system of FIG. 4.

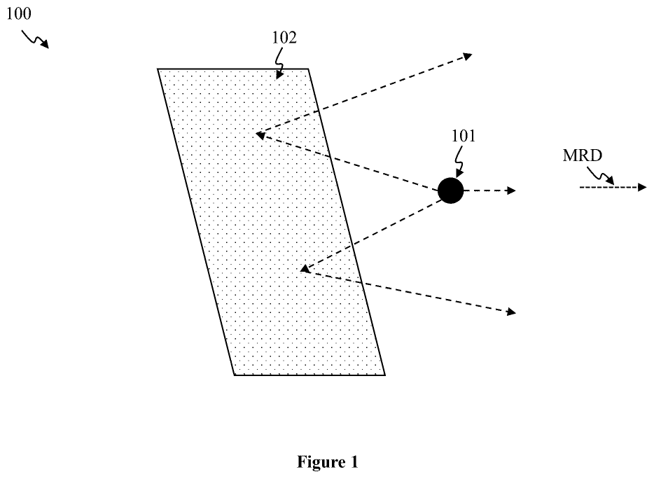

Same elements shown in the Figures are labeled with the same reference sign, and may be implemented likewise.

### DESCRIPTION OF EMBODIMENTS

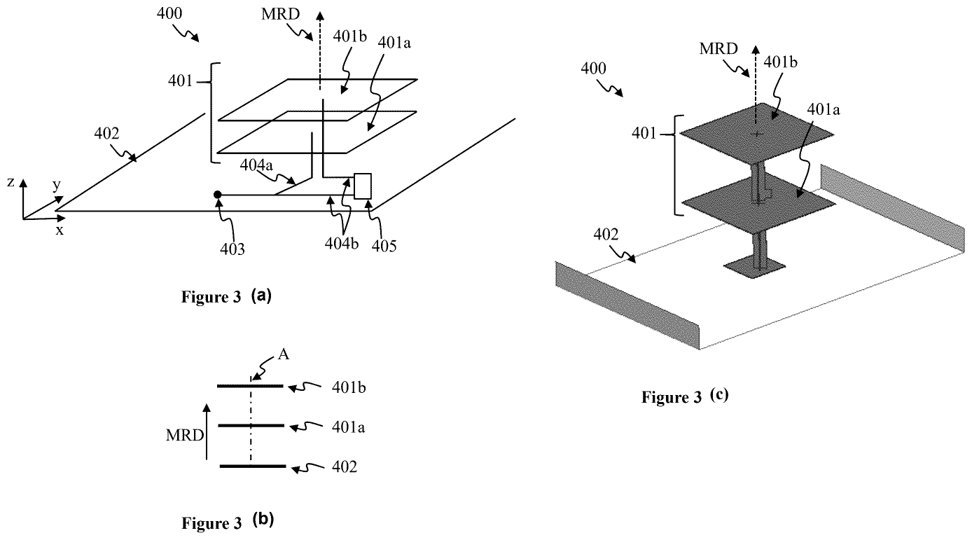

FIGS. 3 (a), 3 (b) and 3 (c) show an example of an antenna device according to this disclosure. The antenna device 400 of FIGS. 3 (a), 3 (b) and 3 (c) is an example of the antenna device according to the first aspect of this disclosure. The description of the antenna device according to the first aspect is correspondingly valid for the antenna device 400 of FIGS. 3 (a), 3 (b) and 3 (c). FIG. 3 (a) schematically shows elements of the antenna device 400, FIG. 3 (b) shows a schematic side view of the antenna device 400, and FIG. 3 (c) shows a perspective view of the antenna device 400.

The antenna device 400 of FIGS. 3 (a), 3 (b) and 3 (c) may be a broadband antenna device and/or may be an antenna device that is suitable for massive multiple input multiple output (mMIMO). As shown in FIG. 3 (a), the antenna device 400 comprises a node 403 for being fed with a radio frequency (RF) signal from a feed structure (the feed structure is not shown in FIGS. 3 (a), 3 (b) and 3 (c)). That is, the node 403 is a node for receiving the RF signal from the feed structure. The antenna device 400 comprises a first radiating element 401a being arranged in a first plane and configured to radiate a radio wave in response to the RF signal being fed to the first radiating element 401a via the node 403. The antenna device 400 comprises a second radiating element 401b being arranged in a second plane that is different to the first plane and being configured to radiate a radio wave in response to the RF signal being fed to the second radiating element 401b via the node 403. The antenna device 400 comprises a non-reflective plate 402 arranged in a third plane that is different to the first plane and the second plane. The antenna device is configured such that the RF signal is fed via the node 403 to the first radiating element 401a and the second radiating element 401b with a difference of phase between the first radiating element 401a and the second radiating element 401b. The first radiating element 401a is arranged between the second radiating element 401b and the non-reflective plate 402.

As shown in FIG. 3 (a), the first radiating element 401a may be fed with the RF signal from the node 403 via a feed line 404a. The second radiating element 401b may be fed with the RF signal from the node 403 via a feed line 404b. The feed structure (not shown in FIGS. 3 (a), 3 (b) and 3 (c)) may be an external element with regard to the antenna device 400 that may be coupled, e.g. electrically connected, to the antenna device 400, e.g. to a port of the antenna device 400, in order to feed the RF signal to the node 403 and, thus, via the node 403 to the first radiating element 401a and second radiating element 401b. Optionally, the antenna device 400 may comprise the feed structure and the feed structure may be configured to feed the node 403.

As shown in FIG. 3 (a), the antenna device 400 optionally may comprise a phase shifter 405 arranged between the node 403 and the second radiating element 401b. That is, the phase shifter 405 may be arranged in the feed line 404b for feeding the RF signal from the node 403 to the second radiating element 401b. Alternatively, the phase shifter 405 may be arranged between the node 403 and the first radiating element 401a (not shown in FIG. 3 (a)). That is, the phase shifter 405 may be arranged in the feed line 404a for feeding the RF signal from the node 403 to the first radiating element 401a. The phase shifter 405 is configured to provide the difference of phase between the first radiating element 401a and the second radiating element 401b of the RF signal when the RF signal is fed to the first radiating element 401a and the second radiating element 401b via the node 403 (from the feed structure). In addition or alternatively, the antenna device 400 may optionally be differently configured for providing the difference of phase between the first radiating element 401a and the second radiating element 401b. For example, at least one of the feed lines 404a and 404b may be configured to provide such difference in phase, e.g. by comprising a meandering portion. In the aforementioned optionally case, the antenna device 400 optionally does not comprise the phase shifter 405.

The first radiating element 401a and the second radiating element 401b are a radiating source 401 of the antenna device 400. They may form a dual layer antenna. The first radiating element 401a and the second radiating element 401b may radiate radio waves in response to the RF signal being fed to the first radiating element 401a and second radiating element 401b in a main radiating direction MRD. As indicated in FIG. 3 (a), the main radiating direction MRD may be the normal direction away from the non-reflective plate 402. The normal direction corresponds to the direction of the z-axis of the coordinate system shown FIG. 3 (a). As shown in FIG. 3 (a), the first, second and third plane each extend in the direction of the y-axis and direction of the x-axis. Thus, the first radiating element 401a, second radiating element 401b and the non-reflective plate 402 extend in the direction of the y-axis and direction of the x-axis.

As shown in FIG. 3 (a) and FIG. 3 (c), the first radiating element 401a and the second radiating element 401b may each comprise a planar element arranged in its respective plane. For example, the first radiating element 401a and the second radiating element 401b may each comprise a printed circuit board (PCB) substrate on which a radiating structure, e.g. a dipole, is defined, wherein the PCB substrate is arranged in the first plane (in case of the first radiating element 401a) or the second plane (in case of the second radiating element 401b), respectively.

The non-reflective plate 402 may be a planar element arranged in the third plane that allows radio waves to pass through. The non-reflective plate 402 may be made of one or more materials that allow radio waves to pass through. For example, the one or more materials may comprise at least one of one or more plastics, one or more dielectrics etc. The non-reflective plate 402 may be made of a material composition that allows radio waves to pass through.

As shown in FIG. 3 (b), the first radiating element 401a, the second radiating element 401b and the non-reflective plate 402 may be arranged on a common axis A. The main radiating direction MRD is the direction away from the non-reflective plate 402 along the common axis A. The first and second radiating element 401a, 401b may be arranged concentrically on the common axis A. This may mean that the common axis A may run through a center of gravity of each radiating element 401a, 401b. The radiating elements 401a, 401b of the antenna device 100 may thus be considered collocated.

The first radiating element 401a and the second radiating element 401b may be stacked to each other. In particular, they may be stacked in the normal direction with respect to the non-reflective plate 402.

For further details on the antenna device 400 of FIGS. 3 (a), 3 (b) and 3 (c) reference is made to the description of the antenna device according to the first aspect of this disclosure.

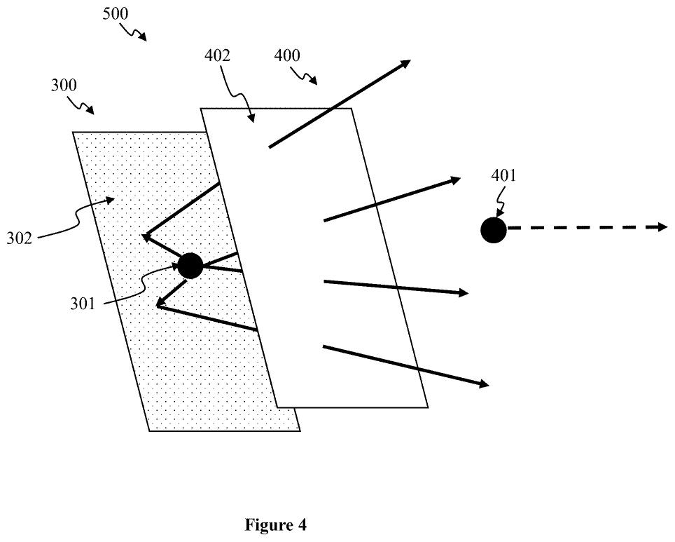

FIG. 4 shows an example of an antenna system according to this disclosure. The antenna system 500 of FIG. 4 is an example of the antenna system according to the second aspect of this disclosure. The description of the antenna system according to the second aspect is correspondingly valid for the antenna system 500 of FIG. 4.

The antenna system 500 of FIG. 4 comprises an antenna device 400 of FIGS. 3 (a), 3 (b) and 3 (c) and a second antenna device 300. The antenna device 400 and the second antenna device 300 are configured to be arranged such that the non-reflective plate 402 of the antenna device 400 is arranged between the first radiating element 401a of the antenna device 400 and the second antenna device 300. That is, the antenna device 400 and the second antenna device 300 may be arranged such that the non-reflective plate 402 of the antenna device 400 is arranged between the radiating source 401 of the antenna device 400 and the second antenna device 300. The second antenna device 300 is configured to radiate one or more radio waves (represented by solid arrows) in the direction of the non-reflective plate 402 of the antenna device 400. Since the non-reflective plate 402 allows radio waves to pass through, the one or more radio waves radiated by the second antenna device 300 pass through the non-reflective plate 402, as indicated in FIG. 4. That is, the second antenna device 300 is configured to radiate one or more radio waves through the non-reflective plate 402 of the antenna device 400. The second antenna device 300 may be a broadband antenna device and/or may be an antenna device that is suitable for massive multiple input multiple output (mMIMO).

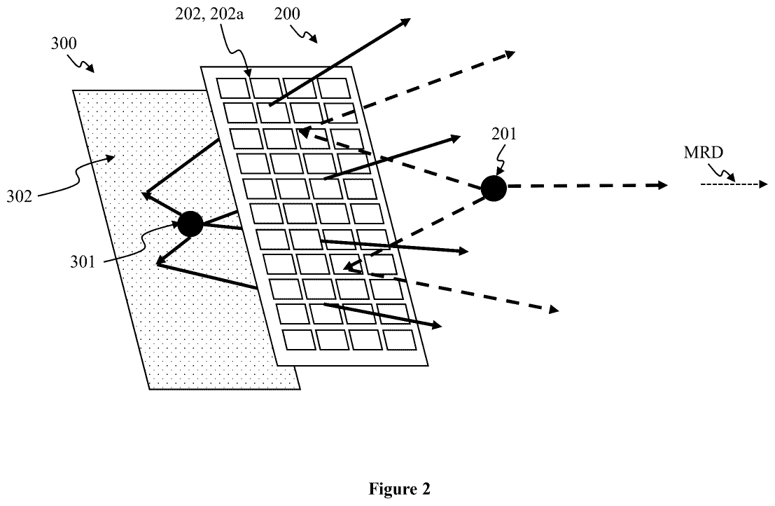

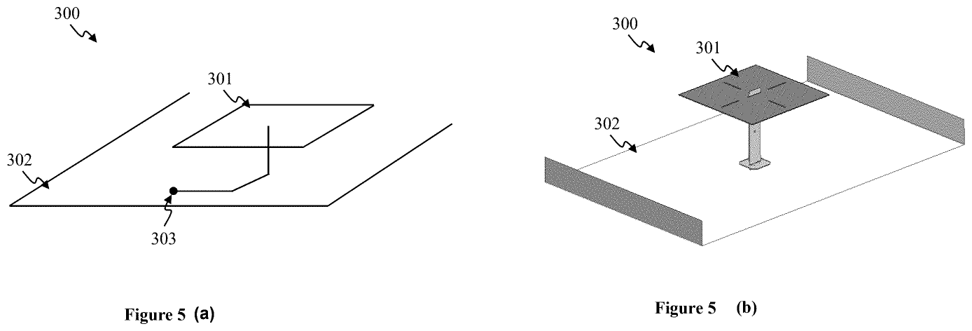

As shown in FIG. 4, the second antenna device 300 may be the second antenna device 300 of the two antenna devices shown in FIG. 2. For a description of the second antenna device 300 of the antenna system 500 of FIG. 4 reference is made to the description of the second antenna device 300 of FIG. 2. The second antenna device 300 of the antenna system 500 may be differently implemented, i.e. a different type of antenna device may be used for the second antenna device. An example of an implementation form of the second antenna device 300 of the system 500 of FIG. 4 is described with regard to FIGS. 5 (a) and 5 (b). For a description of the antenna device 400 of the system 500 of FIG. 4 reference is made to the description of the antenna device 400 of FIGS. 3 (a), 3 (b) and 3 (c).

As shown in FIG. 4, since the antenna device 400 comprise the non-reflective plate 402 (instead of a reflector), the radiating source 301 of the second antenna device 300 may radiate radio waves through the non-reflective plate 402 and, thus, through the antenna device 400. Thereby, the second antenna device 300 may radiate radio waves (represented by solid arrows) in the same direction as a direction, in which the radiating source 401 of the antenna device 400 radiates radio waves (represented by a dashed arrow). Therefore, it is possible to arrange the second antenna device 300 with regard to the antenna device 400 such that the non-reflective plate 402 of the antenna device 400 is arranged between the first radiating element 401a of the antenna device 400 and the second antenna device 300; Thus, the antenna device 400 allows mounting the second antenna device 300 to the antenna device 400 on a first side of the non-reflective plate 402 that is opposite to a second side of the non-reflective plate 402 facing the radiating source 401, i.e. the first radiating element 401a, of the antenna device 400. That is, the second side of the non-reflective plate 402 is the side of the non-reflective plate 402 where the radiating source 401, i.e. the first radiating element 401a, of the antenna device 400 is arranged. Thus, the non-reflective plate 402 of the antenna device 400 allows rear mounting the second antenna device 300 on the back of the antenna device 400. The back of the antenna device 400 is where the non-reflective plate 402 is arranged and a front of the antenna device 400 is where the radio waves are radiated from the radiating source 401, i.e. from the first and second radiating element 401a, 401b.

The antenna device 400 may be a passive antenna device and the second antenna device 300 may be an active antenna device.

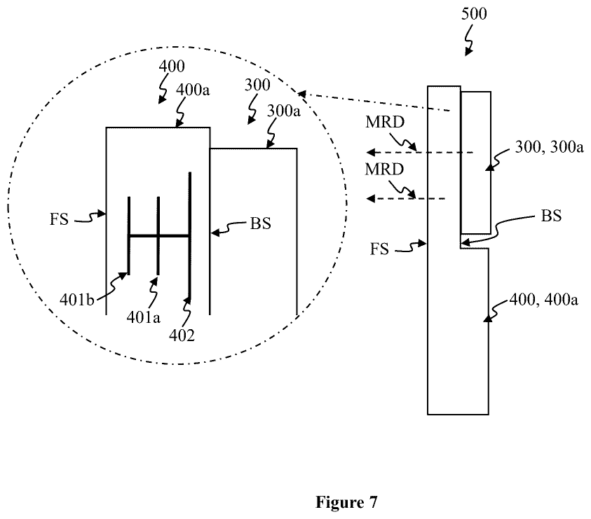

For further details on the antenna system 500, e.g. optional implementation forms and/or optional features, reference is made to the description of the antenna system according to the second aspect of this disclosure and the description of FIG. 7.

FIGS. 5 (a) and 5 (b) show an example of the second antenna device of the antenna system of FIG. 4. The description of the second antenna device 300 of FIG. 4 is correspondingly valid for the antenna device 300 of FIGS. 5 (a) and 5 (b). FIG. 5 (a) schematically shows elements of the antenna device 300 and FIG. 5 (b) shows a perspective view of the antenna device 300.

As shown in FIG. 5 (a), the antenna device 300 comprises a node 303 for being fed with a radio frequency (RF) signal from a feed structure (not shown in FIGS. 5 (a) and 5 (b)). The antenna device 300 comprises a radiating element 301 being arranged in a first plane and configured to radiate a radio wave in response to the RF signal being fed to the first radiating element 301 via the node 303 (from the feed structure). The antenna device comprises a reflector 302 arranged in a second plane that is different to the first plane.

The first plane and the second plane may be parallel to each other. The radiating element 301 and the reflector 302 may be positioned such that the radio waves radiated by the first radiating element 301 are radiated in a main radiating direction away from the reflector 302. The antenna device 300 is described as a transmission (not reception) device. However, it can also be operated as a reception device.

The radiating element 301 and the reflector 302 may be arranged on a common axis. The main radiating direction may be the direction away from the reflector 302 along the common axis. The radiating element 301 may comprise a dipole. For example, the radiating element 301 may comprise a planar element arranged in its respective plane, e.g. a printed circuit board (PCB) substrate on which a radiating structure, e.g. a dipole, is defined. The reflector 302 may comprise a planar element arranged in the second plane. For example, the reflector 302 may be a reflector plate arranged in the second plane.

The antenna device 300 may be a broadband antenna device and/or may be an antenna device that is suitable for massive multiple input multiple output (mMIMO). The antenna device 300 may be a massive multiple input multiple output antenna device (mMIMO antenna device).

The radiating source of the antenna device 300 provided by the radiating element 301 may be differently implemented. For example, the radiating source of the antenna device 300 may be implemented in line with the radiating source 401 of the antenna device 400 of FIGS. 3 (a), 3 (b) and 3 (c). That is, the radiating source of the antenna device 300 may be for example a dual layer antenna. The description of the antenna device 400 of FIGS. 3 (a), 3 (b) and 3 (c) is correspondingly valid for describing such an optional radiating source.

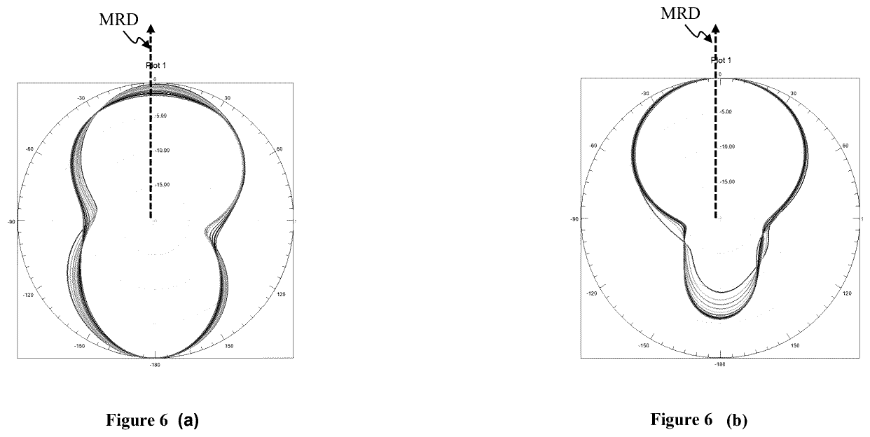

FIG. 6 (a) shows an example of a radiation patter of an antenna device, in case the antenna device is implemented in line with the antenna device 300 of FIGS. 5 (a) and 5 (b), but comprises a non-reflective plate instead of the reflector 302. FIG. 6 (b) shows an example of a radiation patter of the antenna device according to FIGS. 3 (a), 3 (b) and 3 (c).

As may be derived from FIGS. 6 (a) and 6 (b) using a dual layer antenna, i.e. a first radiating element 401a and 401b implemented in the antenna device 400 of FIGS. 3 (a), 3 (b) and 3 (c), allows improving the directivity of the resulting radiation pattern so that using the non-reflective plate 402 instead of a reflector (antenna reflector) still allows achieving a sufficient radiation pattern for radiating radio waves in the main radiating direction MRD. In other words, using the dual layer antenna design for the radiating source 401 of the antenna device 400 of FIGS. 3 (a), 3 (b) and 3 (c) allows the radiating source 401 to work independently of a reflector, i.e. there is no need of a reflector being present for reflecting radio waves radiated by the radiating source 401 in order to achieve a sufficient radiation of radio waves in a main radiating direction MRD. This due to the increased directivity of the dual layer antenna design compared to a single layer antenna design, such as the one exemplarily shown in FIGS. 5 (a) and 5 (b). In other words, the dual layer antenna design allows the radiating source 401 of the antenna device 400 to radiate more in a predetermined direction without profiting from reflections at a reflector. Therefore, using the dual layer antenna design for the radiating source 401 of the antenna device 400 of FIGS. 3 (a), 3 (b) and 3 (c) allows using the non-reflective plate 402 instead of a reflector.

FIG. 7 shows an example of an implementation form of the antenna system of FIG. 4. The description of the antenna system of FIG. 4 is correspondingly valid for the antenna system 500 of FIG. 7.

As shown in FIG. 7, the antenna device 400 may comprise a housing 400a, such as a radome, and the second antenna device 300 may comprise a housing 300a, such as a radome. A shown in the dashed circle, the housing 400a of the antenna device 400 may enclose the first radiating element 401a, the second radiating element 401b and the non-reflective plate 402. The housing 400a of the antenna device 400 may be configured to be connected with the housing 300a of the second antenna device 300 such that the housing 300a of the second antenna device 300 is arranged at a side BS of the housing 400a of the antenna device 400, at which the non-reflective plate 402 is arranged in the housing 400a of the antenna device 400. This side BS may be referred to as back side of the housing 400a of the antenna device 400. In other words, the housing 300a of the second antenna device 300 may be configured to be rear mounted on the back BS of the housing 400a of the antenna device 400. The housing 300a of the second antenna device 300 may be configured to be mounted to the housing 400a of the antenna device 400 at the side BS of the housing 400a of the antenna device 400, at which the non-reflective plate 402 is arranged in the housing 400a, such that a main radiating direction MRD of the second antenna device 300 is in a direction towards the non-reflective plate 402 of the antenna device 400. As indicated in FIG. 7, the radio waves are radiated at a front side FS (i.e. front) of the antenna device 400 in a main radiating direction MRD away from a back side BS (i.e. back) of the antenna device 400.

At least a part of at least one of the first radiating element 401a, second radiating element 401b and non-reflective plate 402 may be arranged outside the housing 400 or protrude out of the housing 400a.

For further details on the system 500 of FIG. 7 reference is made to the description of the system of the second aspect of this disclosure and to the description of the system 500 of FIG. 4.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. An antenna device comprising:
a node;
a first radiating element in a first plane and coupled with the node, the first radiating element being configured to radiate a radio wave in response to a radio frequency (RF) signal being fed to the first radiating element by way of the node;
a second radiating element in a second plane different from the first plane and coupled with the node, the second radiating element being configured to radiate a radio wave in response to the RF signal being fed to the second radiating element by way of the node; and
a non-reflective plate in a third plane different from the first plane and the second plane,
wherein
the antenna device is configured such that the RF signal is fed to the first radiating element and the second radiating element with a difference of phase between the first radiating element and the second radiating element, and
the first radiating element is between the second radiating element and the non-reflective plate.

2. The antenna device according to claim 1, wherein
the first radiating element and the second radiating element are positioned such that the radio waves radiated by the first radiating element and the second radiating element interfere constructively in a main radiating direction.

3. The antenna device according to claim 1, further comprising:
a phase shifter between the node and the first radiating element or second radiating element,
wherein the phase shifter is configured to provide the difference of phase between the first radiating element and the second radiating element of the RF signal when the RF signal is fed to the first radiating element and the second radiating element by way of the node.

4. The antenna device according to claim 3, wherein
the first radiating element and the second radiating element are positioned such that, and the phase shifter is configured such that, the radio waves radiated by the first radiating element and the second radiating element interfere constructively in a main radiating direction.

5. The antenna device according to claim 1, wherein
the first radiating element, the second radiating element, and the non-reflective plate are arranged on a common axis.

6. The antenna device according to claim 2 wherein
the main radiating direction in a direction away from the non-reflective plate.

7. The antenna device according to claim 1, wherein
the first radiating element and the second radiating element are stacked to each other.

8. The antenna device according to claim 1, wherein
the first radiating element comprises a first dipole, and
the second radiating element comprises a second dipole.

9. The antenna device according to claim 1, wherein
the antenna device is a first antenna device configured to be connected with a second antenna device such that the second antenna device is on a first side of the non-reflective plate opposite to a second side of the non-reflective plate, and
the first radiating element and the second radiating element are on the second side of the non-reflective plate.

10. The antenna device according to claim 1, further comprising:
a radome,
wherein the first radiating element, the second radiating element, and the non-reflective plate are in the radome.

11. The antenna device according to claim 1, wherein
the antenna device is a passive antenna device.

12. (canceled)

13. An antenna system comprising
a first antenna device; and
a second antenna device,
wherein
the first antenna device and the second antenna device individually comprise:
a node;
a first radiating element in a first plane and coupled with the node, the first radiating element being configured to radiate a radio wave in response to a radio frequency (RF) signal being fed to the first radiating element by way of the node;
a second radiating element in a second plane different from the first plane and coupled with the node, the second radiating element being configured to radiate a radio wave in response to the RF signal being fed to the second radiating element by way of the node; and
a non-reflective plate in a third plane different from the first plane and the second plane,
wherein
the antenna device is configured such that the RF signal is fed to the first radiating element and the second radiating element with a difference of phase between the first radiating element and the second radiating element, and
the first radiating element is between the second radiating element and the non-reflective plate,
the first antenna device and the second antenna device are configured to be arranged such that the non-reflective plate of the first antenna device is between the first radiating element of the first antenna device and the second antenna device, and
the second antenna device is configured to radiate one or more radio waves toward the non-reflective plate.

14. The antenna system according to claim 13, wherein
the first antenna device comprises a first radome, and
the second antenna device a second radome.

15. The antenna system according to claim 13, wherein
the first antenna device and the second antenna device are configured to work on different frequency bands.
